(19) United States
(12) Patent Application Publication
(10) Pub. No.: US 2010/0235243 A1
(43) Pub. Date: Sep. 16, 2010

(54) Remnant Inventory Marketplace for Placement of Advertisements

(76) Inventor: Greg Hecht, Mountain View, CA (US)

Correspondence Address: FISH & RICHARDSON P.C., PO BOX 1022, MINNEAPOLIS, MN, 55440-1022, US

(21) Appl. No.: 12/402,642

(22) Filed: Mar. 12, 2009

(51) Int. Cl. G06Q 30/00; H04N 7/025

(52) U.S. Cl. 705/14.71; 725/32; 705/26; 705/34

(57) ABSTRACT

The subject matter of this specification can be implemented in, among other things, a computer-implemented method for assigning remnant advertisement availabilities including receiving bids for a plurality of advertisement availabilities, each of the bids including an amount being bid for a specific advertisement availability among the advertisement availabilities. The method further includes auctioning the advertisement availabilities using the bids. The method further includes determining, as a result of auctioning the advertisement availabilities, a remaining advertisement availability from the advertisement availabilities that was not auctioned. The method further includes receiving offers for the remaining advertisement availability, each of the offers having corresponding budgets for non-specific advertisement availabilities. The method further includes selecting from the offers an offer having a remaining budget that is greater than or equal to a minimum charge incurred by the remaining advertisement availability. The method further includes assigning the remaining advertisement availability to the selected offer.

### TECHNICAL FIELD

This instant specification relates to placement of advertisements in advertisement availabilities.

### BACKGROUND

An advertiser, such as a business entity, can purchase airtime during a television broadcast to air television advertisements. Example television advertisements include commercials that are aired during a program break, transparent overlays that are aired during a program, and text banners that are aired during a program.

The cost of the advertisement airtime purchased by the advertiser varies according to both the amount of time purchased and other parameters such as the audience size and audience composition expected to be watching during the purchased airtime or closely related to the purchased airtime. In some cases, the audience size can relate to a number of times that the advertisement is presented on a media and can be referred to as a number of impressions of the advertisement. The audience size and audience composition for a given placement of an advertisement, for example, can be measured by a ratings system. Data for television ratings can, for example, be collected by viewer surveys in which viewers provide a diary of viewing habits; or by set-top box metering devices that automatically collect viewing habit data and transmit the data over a wired or wireless connection, e.g., a phone line or cable line; or by digital video recorder service logs, for example. Such rating systems, typically provide an estimate of the actual audience numbers and audience composition.

Based on the ratings estimate, airtime is offered to advertisers for a fee. Typically the advertiser must purchase the airtime well in advance of the airtime.

### SUMMARY

This document describes placing advertisement availabilities that remain after bids for the advertisement availabilities in an advertisement auction have been processed. In some implementations, offers are received for the remaining advertisement availabilities. In some implementations, the offers include fewer restrictions than the bids, such as no specific cost-per-impression amount or no specific television network and daypart for a television advertisement availability.

In a first aspect, a computer-implemented method for assigning remnant advertisement availabilities includes receiving one or more bids for at least one of a plurality of advertisement availabilities, each of the bids includes an amount being bid for a specific advertisement availability among the advertisement availabilities. The method further includes auctioning the advertisement availabilities using the bids. The method further includes determining, as a result of auctioning the advertisement availabilities, at least one remaining advertisement availability from the advertisement availabilities that was not auctioned. The method further includes receiving one or more offers for the remaining advertisement availability, each of the offers having corresponding budgets for one or more non-specific advertisement availabilities. The method further includes selecting from the offers an offer having a remaining budget that is greater than or equal to a minimum charge incurred by the remaining advertisement availability. The method further includes assigning the remaining advertisement availability to the selected offer.

Implementations can include any, all, or none of the following features. The advertisement availabilities can include television networks and dayparts. The amounts being bid can each be for a specific television network and daypart among the television networks and dayparts while the offers do not specify a television network and daypart. The method can include providing an advertisement associated with the selected offer to a publisher associated with the remaining advertisement availability. The method can include billing the minimum charge to an advertiser associated with the selected offer. The offers can have an order and selecting from the offers can further include selecting each of the offers in order before selecting any of the offers a subsequent time. Selecting the offer can further include maximizing a number of fulfilled advertisement pods. The amounts being bid can each include a cost per impression amount for the specific advertisement availabilities. The offers can each include a range of accepted cost per impression amounts for the remaining advertisement availability. The budgets for the non-specific advertisement availabilities can each include a daily budget for the non-specific advertisement availabilities.

In a second aspect, a computer-implemented method for assigning remnant advertisement availabilities includes receiving one or more requests to purchase at least one of a plurality of advertisement availabilities, each of the requests includes an amount being paid for a specific advertisement availability among the advertisement availabilities. The method further includes determining, as a result of the requests, at least one remaining advertisement availability from the advertisement availabilities that was not purchased. The method further includes receiving one or more offers for the remaining advertisement availability, each of the offers includes corresponding budgets for one or more non-specific advertisement availabilities. The method further includes selecting from the offers an offer having a remaining budget that is greater than or equal to a minimum charge incurred by the remaining advertisement availability. The method further includes assigning the remaining advertisement availability to the selected offer.

In a third aspect, a computer-implemented system for assigning remnant advertisement availabilities includes a memory that stores advertisement availabilities. The system further includes an advertiser interface that receives one or more bids and one or more offers for the advertisement availabilities from multiple advertiser systems, each of the bids includes an amount being bid for a specific advertisement availability among the advertisement availabilities, and each of the offers includes a corresponding budget for one or more non-specific advertisement availabilities among the advertisement availabilities. The system further includes an advertisement auction module that auctions the advertisement availabilities using the bids and determines, as a result of auctioning the advertisement availabilities, a remaining advertisement availability that was not auctioned. The system further includes an offer selection module that selects from the offers an offer having a remaining budget that is greater than or equal to a minimum charge incurred by the remaining advertisement availability, and that assigns the remaining advertisement availability to the selected offer.

Implementations can include any, all, or none of the following features. The system can include a publisher interface that receives the advertisement availabilities from one or more publisher systems and stores the received advertisement availabilities in the memory.

The systems and techniques described here may provide one or more of the following advantages. First, a system can provide a simple way for advertisers to obtain placements in advertisement availabilities, such as television commercial slots, print advertisement slots, or online advertisements slots. Second, a system can provide placement of an advertisement using a minimum of information requested from the advertiser, such as a maximum budget to be spent over some period of time, an average cost or range of costs per placement, and the advertisement to be placed Third, a system can provide placement of advertisements in advertisement availabilities that would otherwise go unfilled had the advertisement availabilities relied solely on an advertisement auction. Fourth, a system can provide placement of advertisements in advertisement availabilities for advertisers that are not familiar with the types of values and the typical amounts of the values associated with a full advertisement bidding process, such as a television network, a television daypart, and a cost per impression amount. Fifth, a system can provide for fulfilling a complete block or pod of availabilities with advertisements from paying advertisers where some of the availabilities remain unfulfilled after performing an initial auction of the availabilities.

The details of one or more implementations are set forth in the accompanying drawings and the description below. Other features and advantages will be apparent from the description and drawings, and from the claims.

### DESCRIPTION OF DRAWINGS

FIG. 1 is a schematic diagram showing an example of a system for assigning a remnant advertisement availability.

FIG. 2 is a block diagram showing an example of a system for selecting an offer for which to assign a remnant advertisement availability.

FIG. 3 shows an example of a user interface for inputting an offer for a remnant advertisement availability.

FIG. 4 is a flow chart showing an example of a process for assigning a remnant advertisement availability.

FIG. 5 is a schematic diagram showing an example of a computing system that can be used in connection with computer-implemented methods and systems described in this document.

Like reference symbols in the various drawings indicate like elements.

### DETAILED DESCRIPTION

This document describes systems and techniques for assigning advertisement availabilities that remain after performing an advertisement auction. For example, publishers, such as television networks, print media, radio media, and online media, provide slots or advertisement availabilities in which advertisements from advertisers may be placed. The advertisers can participate in an initial marketplace or auction for those advertisement availabilities.

Some advertisement availabilities go unplaced after performing an initial auction. For example, a particular advertisement availability may receive no bids during the auction and go unplaced after the auction. In another example, an advertiser may bid on the advertisement availability, but the amount of the bid may be less than a minimum bid amount (possibly unknown to the advertiser) required by the publisher. In another example, an advertiser may bid an amount above the minimum amount for the advertisement availability, but less than an amount remaining in a daily or other periodic budget for the advertiser. In another example, restrictions may be placed on the advertisers that result in an availability remaining unplaced, such as by preventing the same advertisement from being presented back-to-back with itself or back-to-back with an advertisement for the same type of product or service.

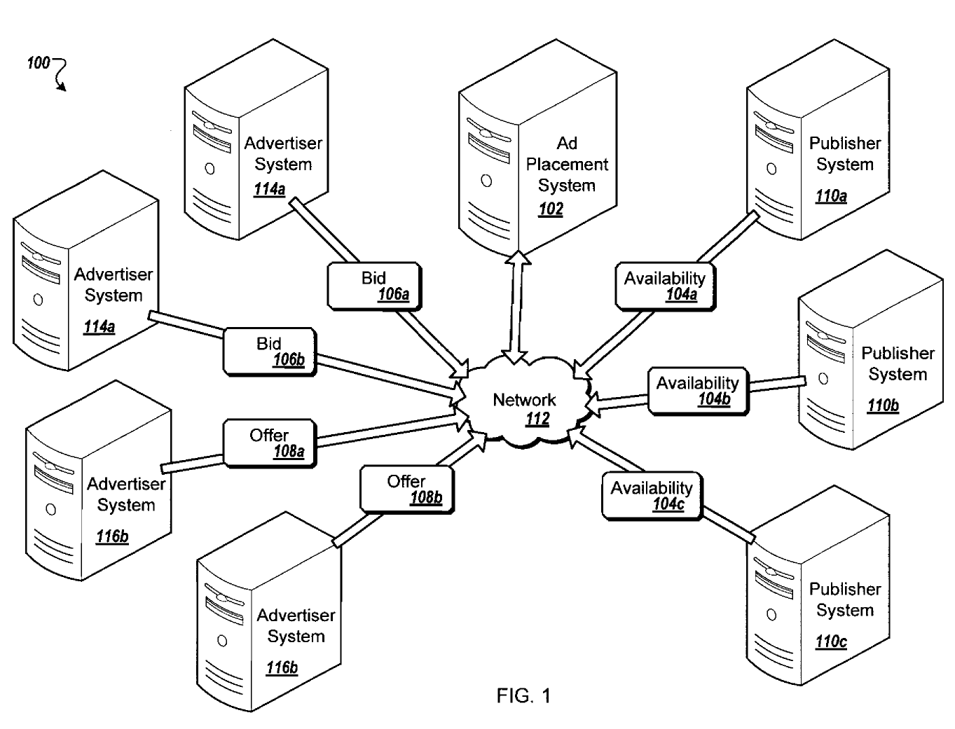

These unplaced advertisement availabilities are referred to as a remnant inventory of advertisement availabilities. FIG. 1 is a schematic diagram showing an example of a system 100 for assigning a remnant advertisement availability. The system 100 includes an advertisement placement system 102.

The advertisement placement system 102 first determines remnant advertisement availabilities by performing an initial auction or other initial placement of availabilities. To perform the auction, the advertisement placement system 102 receives multiple advertisement availabilities 104a-c, one or more advertisement bids 106a-b, and one or more advertisement offers 108a-b. The advertisement placement system 102 then performs the auction of the advertisement availabilities 104a-c using the advertisement bids 106a-b to assign one or more of the advertisement availabilities 104a-c to advertisers. The advertisement placement system 102 uses the advertisement offers 108a-b and/or other information to assign the advertisement availabilities that remain after the auction to the same or other advertisers.

The advertisement placement system 102 receives the advertisement availabilities 104a-c from multiple publisher systems 110a-c, respectively, over a network 112, such as a wide area network or the Internet. Alternatively, the advertisement availabilities 104a-c can be communicated to the advertisement placement system 102 in another way, such as by postal mail, fax, or a telephone call.

The advertisement availabilities 104a-c include information that describes the available slot for the advertisement. For example, the advertisement availability 104a may include a television network and daypart (e.g., television network “XYZ” weekday primetime) that includes information describing the television network the slot appears on, the time of day, the television program, and/or the length of time for the slot. A television advertisement availability may further include a region, such as XYZ weekday primetime presented on the east coast of the United States or XYZ weekday primetime presented on the west coast of the United States. In another example, the advertisement availability 104b may be a print advertisement that includes information describing the periodical the slot appears in, the day of the week the periodical is published, the allowed colors for the slot, and the dimensions of the slot. In some implementations, the information describing the available slot includes or is associated with a typical volume of circulation or number of viewers for the advertisement availability. Other demographic information related to the underlying media may also be provided.

The advertisement placement system 102 receives the advertisement bids 106a-b for the advertisement availabilities 104a-c from multiple advertiser systems 114a-b, respectively, over the network 112. In some implementations, the advertisement bids 106a-b are received over a network separate from a network used for receiving the advertisement availabilities 104a-c and/or the advertisement offers 108a-b. The advertisement bids 106a-b may be received before or after the advertisement availabilities 104a-c.

The advertisement bids 106a-b each include an amount being bid for the advertisement availability. For example, the advertisement bids 106a-b may each include a cost-per-impression amount that the advertisers are willing to pay for advertisement impressions in the availability. The number of impressions is the number of times that an advertisement is presented within an available advertisement slot. For example, a particular advertisement in a television commercial slot may be presented on one hundred thousand televisions or to one hundred thousand people for a number of impressions of one hundred thousand. A cost-per-impression amount may be, for example, $1 per one thousand impressions resulting in a total cost of $1000 for the one hundred thousand impressions. In another example, the amount being bid can be a cost-per-placement amount, such as a fixed amount for a thirty second time slot in a particular television program.

In some implementations, the advertisement bids 106a-b each identify a specific advertisement availability to which the bid applies. For example, a bid for a television advertisement availability may identify a network, a daypart, and or a television program to which the bid applies. In another example, a bid for a newspaper advertisement availability may identify a newspaper, a day of the week the paper is distributed, a section within the paper, a page in the section, and/or a location on the page to which the bid applies.

The advertisement placement system 102 receives the advertisement offers 108a-b for the advertisement availabilities 104a-c from multiple advertiser systems 116a-b, respectively, over the network 112. In some implementations, the advertisement placement system 102 ensures that an advertiser providing a bid for the advertisement auction is not allowed to also provide an offer for remnant advertisement availabilities resulting from the auction.

The advertisement placement system 102 processes the advertisement bids 106a-b to assign one or more of the advertisement availabilities 104a-c to advertisers. The advertisement placement system 102 then assigns an advertisement availability that remains after processing the advertisement bids 106a-b to one of the advertisement offers 108a-b.

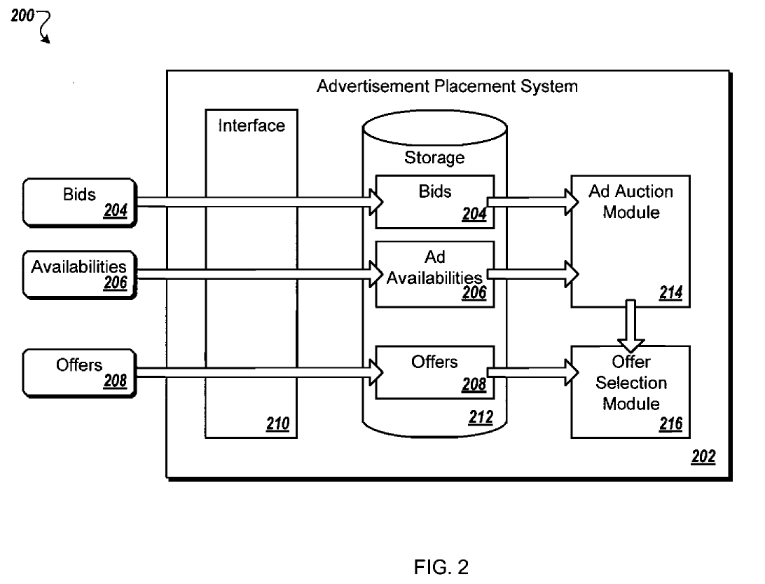

FIG. 2 is a block diagram showing an example of a system 200 for selecting an offer for which to assign a remnant advertisement availability. The system 200 includes an advertisement placement system 202. The advertisement placement system 202 receives multiple bids 204, multiple advertisement availabilities 206, and multiple offers 208 through an interface 210.

The interface 210 can include hardware and software for connecting to a network, such as local or wide area network or the Internet. In some implementations, the interface 210 includes a web server. The web server provides a user interface for publishers and advertisers to submit information regarding the advertisement availabilities 206, the bids 204, and the offers 208. For example, the web server can provide web page forms to the publishers and advertisers that allow them to submit information and upload advertisements to the advertisement placement system 202. In some implementations, the advertisers submit the bids 204 and the offers 208 to the advertisement placement system 202, while a separate system receives the uploads of the advertisements.

The advertisement placement system 202 stores the bids 204, the advertisement availabilities 206, and the offers 208 in a data storage 212. The data storage 212 can be a temporary or volatile memory, such as random access memory, or a long term storage, such as in a database stored on a hard drive. In some implementations, the advertisement placement system 202 generates an index of the information in the bids 204, the advertisement availabilities 206, and the offers 208, such that the information can be quickly retrieved.

The advertisement placement system 202 includes an advertisement auction module 214. The advertisement auction module 214 retrieves an advertisement availability from the advertisement availabilities 206 in the data storage 212. The advertisement auction module 214 also retrieves bids from the bids 204 in the data storage 212 that apply to the retrieved advertisement availability.

For example, the availability may be within an hour long 7:00 PM weeknight national newscast on television network XYZ. The availability specifies the network (“XYZ”), the daypart (7:00 to 8:00 PM weeknight), and the program (national newscast). The bids 204 may include one or more bids for a television network and daypart that includes the availability, such as a primetime weeknight daypart (e.g., 6:00 to 9:00 PM) on network XYZ.

In some implementations, the bids 204 each include a cost per impression amount, such as three bids of $10, $12, and $7 per one thousand impressions. In some implementations, each of the bids 204 can have an associated budget. The budget is the total amount that the advertiser is willing and/or able to spend on advertisement placements, for example, over a time period or per media etc. The budget may be periodic, such as a daily or a weekly budget, or non-periodic. The budgets can be adjusted as advertisements are placed, such that the advertisement placement system 202 tracks the remaining budget for each advertiser or each advertisement campaign from an advertiser. The bids 204 may have, for example, remaining budgets of $1000, $400, and $900, respectively.

The newscast may have a viewership of one hundred thousand viewers. The publisher (television network XYZ) may have a minimum cost per impression amount of $8 for the newscast. This results in the availability having a minimum cost of $800 (e.g., $8 per thousand impressions multiplies by one hundred thousand impressions).

The advertisement auction module 214 performs an auction of the availability. The advertisement auction module 214 identifies the bids 204 as being applicable to the television network and daypart of the availability. The advertisement auction module 214 determines that the bid having a cost per impression amount of $7 is below the minimum amount of $8 an is not eligible for the availability. The advertisement auction module 214 determines that the bid having a cost per impression amount of $12 is the highest, but the remaining budget of $400 is not enough to pay the total cost of $1200 (e.g., $12 per thousand impressions multiplied by one hundred thousand impressions). In some implementations, the total cost can be determined using another process, such as by using the cost per impression amount of the next highest bid.

The advertisement auction module 214 determines that the bid having a cost per impression amount of $10 meets the minimum amount and has enough remaining budget for the one hundred thousand impressions. The advertisement auction module 214 assigns the availability to the advertiser that provided the bid. In some implementations, the advertisement placement system 202 sends an advertisement associated with the bid to the publisher for presentation in the advertisement availability. In some implementations, a separate system sends the advertisement to the publisher.

The advertisement availabilities 206 include an additional availability, for example, having the same television network (network XYZ), daypart (weeknight at 7:00 PM), minimum cost per impression amount of $8, and corresponding total number of impressions (one hundred thousand impressions). Continuing with this example, the advertisement auction module 214 determines that there are no bids that apply to this television network and daypart, that have a cost per impression amount that meets the minimum cost per impression amount, and that have a remaining budget that meets the total cost of the additional availability.

The advertisement auction module 214 provides the additional availability to an offer selection module 216. In some implementations, the advertisement auction module 214 processes all or multiple ones of the advertisement availabilities 206 before providing remnant advertisement availabilities to the offer selection module 216. In some implementations, the advertisement auction module 214 provides each remnant advertisement availability to the offer selection module 216 as the advertisement availability is identified as being a remnant.

The offer selection module 216 receives the additional advertisement availability. The offer selection module 216 selects one of the offers 208 to which the additional advertisement availability is assigned. In some implementations, the offer selection module 216 bases its selection on properties included in or associated with the offers 208.

In some implementations, the offers 208 include, at a minimum, a budget to be spent on advertisement placements. The budget may be included in the offer, associated with the advertiser making the offer, or included in an advertising campaign associated with the offer. The budget may be periodic (e.g., a daily, weekly, or monthly budget) or non-periodic. In some implementations, each of the offers 208 only includes a budget and no other properties that limit the assignment of remnant availabilities to the offers 208.

In some implementations, the offers 208 can include additional properties that are non-specific. Non-specific properties allow the offer selection module 216 to select offers for filling the remnant availabilities without being over-constrained by the limitations in the offers 208. In some implementations, the non-specific properties of the offers 208 have fewer limitations than the specific properties of the bids 204.

For example, the offers 208 can include a range of costs per impression while the bids 204 each include a specific cost per impression. The range of costs per impression can be quantitative, such as $8 to $12. Alternatively, the range of costs per impression can be qualitative, such as a ranking from one to ten with ten being a high cost and one being a low cost. In another example, qualitative cost per impression ranges can include descriptive amounts, such as a “high” range of costs, a “medium” range of costs, and a “low” range of costs. In another example, a qualitative range of costs per impression can describe a related amount, such as a “high” number of advertisement placements (e.g., corresponding to a “low” range of costs per impression) and a “low” number of advertisement placements (e.g., corresponding to a “high” range of costs per impression).

In some implementations, the offer selection module 216 selects one of the offers 208 having a range of costs per impression that includes the minimum cost per impression amount of the additional availability and a remaining budget that meets the total cost of the placement. In some implementations, the offer selection module 216 uses the minimum cost per impression amount when determining the total cost of the placement. For example, the offer selection module 216 can select an offer having a range of $8 to $12 (greater than or equal to the minimum of $8) and a remaining budget of $850 (greater than or equal to the total minimum charge of $800). In some implementations, the offer selection module 216 bases the selection on the remaining budgets of the offers 208 and not on ranges of costs per impression.

The offer selection module 216 assigns the additional advertisement availability to the advertiser that provided the selected offer. In some implementations, the advertisement placement system 202 sends an advertisement associated with the selected offer to the publisher for presentation in the additional advertisement availability. In some implementations, a separate system sends the advertisement to the publisher. In some implementations, the advertisement placement system 202 bills the advertiser associated with the selected offer. For example, the advertisement placement system 202 can bill the advertiser an amount equal to the minimum cost per impression amount of the additional availability multiplied by the total number of impressions.

In some implementations, as the offer selection module 216 assigns additional remnant advertisement availabilities, the offer selection module 216 selects a next offer using round-robin scheduling. For example, the offers 208 may have a particular order, such as the order in which the advertisement placement system 202 receives the offers 208. The offer selection module 216 may assign a first remnant availability to the first offer in the ordered list of offers. The offer selection module 216 may assign a second remnant availability to the second offer in the ordered list of offers. When the last offer has been assigned a remnant availability, the offer selection module 216 then begins again with the first offer.

The round-robin scheduling may skip an offer if the remaining budget of the offer is not sufficient to meet the cost of a placement in the availability. In some implementations, a skipped offer is not given another opportunity for selection until the round-robin scheduling processes repeats again. In some implementations, a skipped offer may remain at the top of the ordering until the offer selection module 216 assigns a remnant availability to it or its remaining budget is below a particular threshold, such as an amount that is about zero or an amount that is less than a minimum total cost of a placement. For example, a minimum total cost of a placement may be $1 (e.g., a minimum cost per impression amount of $1 per one thousand impressions multiplied by one thousand impressions).

While round-robin scheduling is one way to select offers, alternatively, another rule may be used to select offers, such as a rule that examines all or a portion of the remnant availabilities and the offers to maximize the number of remnant availabilities assigned to the offers. For example, a publisher, such as the television network XYZ, can provide some advertisement availabilities as a pod or group. The publisher may require that each of the advertisement availabilities in the pod be assigned by the advertisement placement system 202 in order for the pod to be processed by the advertisement placement system 202. The offer selection module 216 can assign the remnant availabilities in the pod before assigning other remnant availabilities to ensure that the pod is complete. In another example, the offer selection module 216 can use an algorithm in assigning remnant availabilities to offers that minimizes the amount remaining in the budgets of the offers after processing a set of remnant availabilities.

In some implementations, the offer selection module 216 can analyze the remnant advertisement availabilities resulting from the auction to determine a combination of the remnant advertisement availability assignments that maximizes the number of pods that are filled overall. For example, the offer selection module 216 can assign remnant availabilities from pods that are nearly complete before assigning remnant availabilities from pods that are not nearly complete.

In some implementations, the offer selection module 216 can use additional rules for selecting offers. For example, the publisher may provide rules for excluding competitors from placing advertisements in an availability provided by the publisher (e.g., offers from television network BCD are not selected for availabilities from television network XYZ). In some implementations, the offer selection module 216 uses a frequency capping rule in selecting offers. For example, the offer selection module 216 may prevent an offer from being selected in two availabilities that border one another, such as back-to-back television commercials or print ads on the same page.

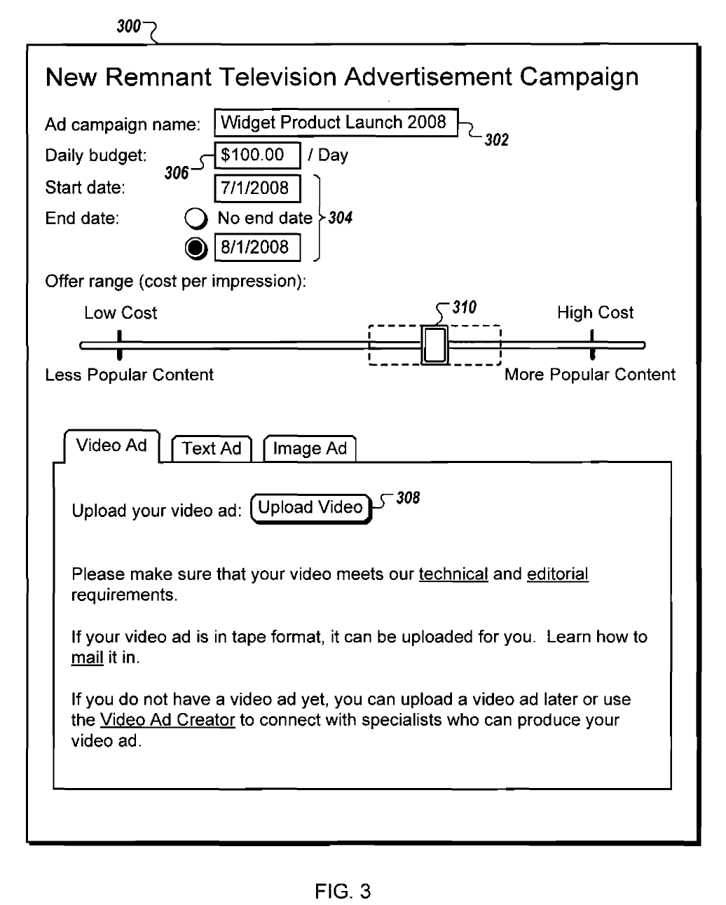

FIG. 3 shows an example of a user interface 300 for inputting an offer for a remnant advertisement availability. The user interface 300 is a web page form for a television advertisement campaign. The user interface 300 includes a name input control 302 that allows a user to input a name for the for the advertisement campaign. The user may be a representative of the advertiser, or a person entering the information on behalf of the advertiser, such as a representative of the advertisement placement system 202. The user interface 300 includes one or more date input controls 304 that allow the user to input or select a range of dates to which the advertisement campaign applies. The user interface 300 includes a budget input control 306 that allows the user to input a budget for the advertisement campaign. The user interface 300 includes an upload control 308 that allows the user to upload a file to the advertisement placement system that includes the advertisement to be placed.

The user interface 300 includes a range input control 310 that allows the user to input a range of costs per impression. The range input control 310 is a slider bar that allows the user to select ranges between a low cost associated with less popular content and a small number of impressions per placement, and a high cost associated with more popular content and a high number of impressions per placement. In some implementations, the user can adjust the width of the range input control 310 allow for a large range or a small range.

In some implementations, the range input control 310 has quantitative indications of the range of costs per impressions in addition to or instead of the qualitative indications. For example, the range input control 310 may indicate the highest and lowest minimum cost per impression amounts for publishers participating in the remnant availability marketplace. In another example, the range input control 310 may indicate the highest and lowest total number of impressions for publishers participating in the remnant availability marketplace. In another example, the range input control 310 may indicate the highest and lowest total cost due to minimum cost per impression and total impressions for publishers participating in the remnant availability marketplace.

In some implementations, the advertisement placement system 202 provides an interface similar to the user interface 300 that allows a user to input a bid for an advertisement. In some implementations, the advertisement placement system 202 provides an interface similar to the user interface 300 that allows a user to input information regarding advertisement availabilities, such as a network, a daypart, restrictions, and a minimum cost per impression amount.

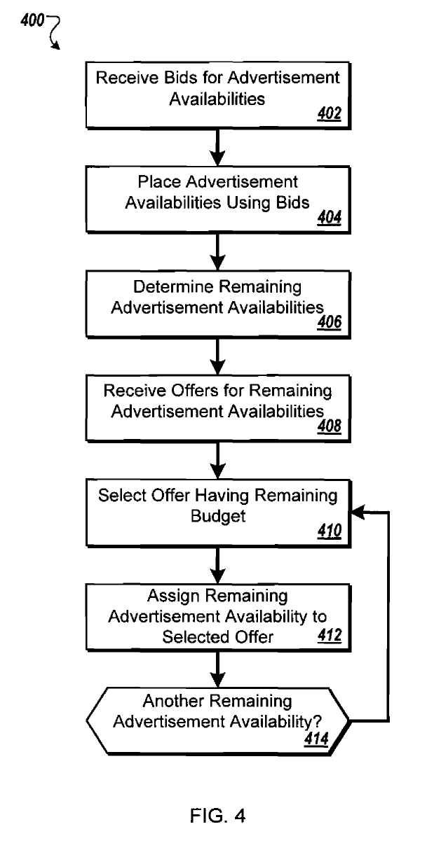

FIG. 4 is a flow chart showing an example of a process 400 for assigning a remnant advertisement availability. The process 400 may be performed, for example, by a system such as the systems 100 and 200. For clarity of presentation, the description that follows uses the systems 100 and 200 as the basis of an example for describing the process 400. However, another system, or combination of systems, may be used to perform the process 400. The process 400 begins with receiving (402) one or more bids for at least one of a plurality of advertisement availabilities. In some implementations, each of the bids includes an amount being bid for a specific advertisement availability among the advertisement availabilities. For example, the advertisement placement system 202 receives the bids 204 through the interface 210. The bids 204 include bid amounts of $10, $12, and $7 per one thousand impressions for a primetime weeknight daypart on television network XYZ.

The process 400 auctions or otherwise places (404) the advertisement availabilities using the bids. For example, the advertisement auction module 214 assigns a first advertisement availability to the bid having a cost per impression amount of $10 as it is the highest bid and has a remaining budget of $1000 that is greater than or equal to the total cost incurred by placement of an advertisement in the first availability.

The process 400 determines (406), as a result of auctioning or another dispositioning technique, at least one remaining advertisement availability from the advertisement availabilities. For example, the advertisement auction module 214 determined that, with regard to the second advertisement availability, the other bids that apply to the primetime newscast on the network XYZ either did not have a cost per impression that was greater than or equal to the minimum cost per impression of the second availability or did not have a remaining budget that was greater than or equal to the total charge incurred by placement in the second availability. As a result, the second availability remains after the advertisement availabilities 206 are auctioned.

The process 400 receives (408) one or more offers for the remaining advertisement availability. In some implementations, each of the offers has a corresponding budget for one or more non-specific advertisement availabilities. In some implementations, a budget is the minimum amount of information needed by the process 400 to select an offer for placement in a remnant availability. In some implementations, an offer can include other non-specific properties, such as a cost per impression range. For example, the offers 208 include an offer having a budget of $850 and a cost per impression range of $8 to $12.

While the receiving (408) of the offers is described here after receiving (402) the bids, initially placing (404) the availabilities, and determining (406) the remnant availabilities, the receiving (408) of the offers can occur at another time. For example, the receiving (408) of the offers can occur before or concurrently with receiving (402) the bids, initially placing (404) the availabilities, and/or determining (406) the remnant availabilities.

The process 400 selects (410) an offer from the offers. For example, a selection can be made based on a remaining budget (i.e., that is greater than or equal to a minimum charge incurred by the remaining advertisement availability). For example, the offer selection module 216 can use a round-robin scheduling process to select the offer having the remaining budget of $850.

The process 400 assigns (412) the remaining advertisement availability to the selected offer. For example, the offer selection module 216 assigns the second availability to the offer having the remaining budget of $850. The advertisement placement system 202 can then provide an advertisement associated with the offer to the publisher that provides the second availability. The publisher places the advertisement in the second availability. The advertisement placement system 202 can bill the minimum total charge for the placement to the advertiser associated with the advertisement.

If there are no remaining advertisement availabilities (414), then the process 400 ends. Otherwise, if there is another remaining advertisement availability (414), then the process 400 selects (410) an offer again. Alternatively, the process 400 can continue to auction (404) the availabilities, determine (406) another remnant availability, select (410) another offer, and assign (412) the additional remnant availability to the additional offer.

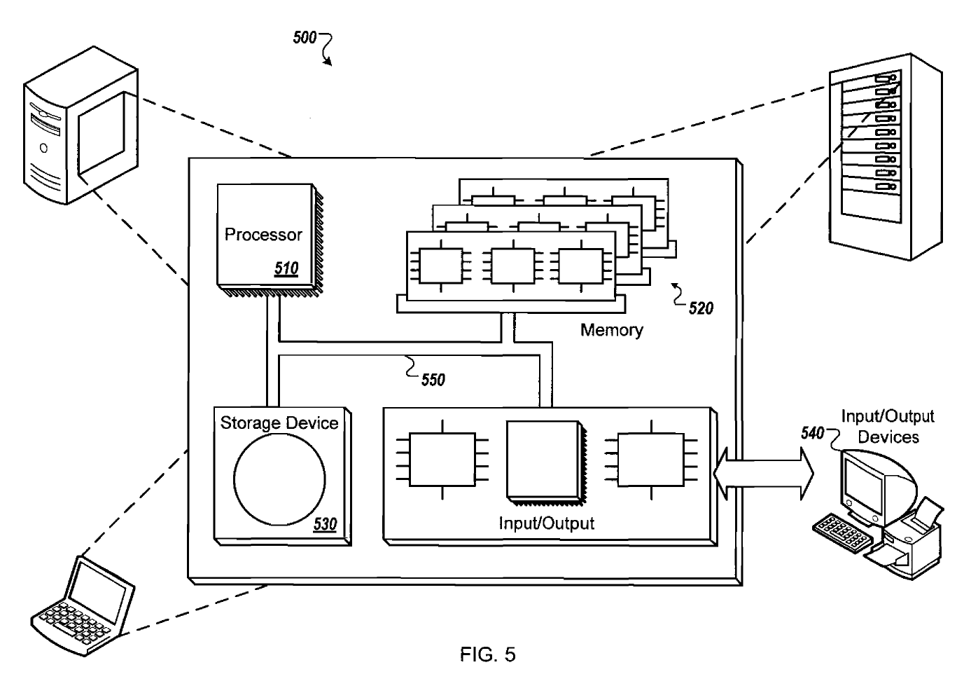

FIG. 5 is a schematic diagram of a computing system 500. The computing system 500 can be used for the operations described in association with any of the computer-implement methods and systems described previously, according to some implementations. The computing system 500 includes a processor 510, a memory 520, a storage device 530, and an input/output device 540. Each of the processor 510, the memory 520, the storage device 530, and the input/output device 540 are interconnected using a system bus 550. The processor 510 is capable of processing instructions for execution within the computing system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the computing system 500. In some implementations, the memory 520 is a computer-readable medium. In some implementations, the memory 520 is a volatile memory unit. In some implementations, the memory 520 is a non-volatile memory unit.

The storage device 530 is capable of providing mass storage for the computing system 500. In some implementations, the storage device 530 is a computer-readable medium. In various different implementations, the storage device 530 may be a floppy disk device, a hard disk device, an optical disk device, or a tape device.

The input/output device 540 provides input/output operations for the computing system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM (erasable programmable read-only memory), EEPROM (electrically erasable programmable read-only memory), and flash memory devices; magnetic disks such as internal hard disks and removable disks; magneto-optical disks; and CD-ROM (compact disc read-only memory) and DVD-ROM (digital versatile disc read-only memory) disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN (local area network), a WAN (wide area network), and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, while the initial placement of advertisement availabilities has been referred to as an auction, the initial placement can be made by another method. The bids can be requests to purchase a particular advertisement placement. The purchase requests can be processed, for example, on a first-come-first-served basis. The advertisement availabilities remaining after the purchase requests have been processed can then be assigned to the offers for the remnant inventory.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

What is claimed is:

1. A computer-implemented method for assigning remnant advertisement availabilities, comprising:
receiving one or more bids for at least one of a plurality of advertisement availabilities, each of the bids including an amount being bid for a specific advertisement availability among the advertisement availabilities;
auctioning the advertisement availabilities using the bids;
determining, as a result of auctioning the advertisement availabilities, at least one remaining advertisement availability from the advertisement availabilities that was not placed during the auction;
receiving one or more offers for the remaining advertisement availability, each of 11 the offers having corresponding budgets for one or more non-specific advertisement availabilities;
selecting from the offers an offer having a remaining budget that is greater than or equal to a minimum charge incurred by the remaining advertisement availability; and
assigning the remaining advertisement availability to the selected offer.

2. The method of claim 1, wherein the advertisement availabilities include television networks and dayparts.

3. The method of claim 2, wherein the amounts being bid are each for a specific television network and daypart among the television networks and dayparts and the offers do not specify a television network and daypart.

4. The method of claim 1, further comprising providing an advertisement associated with the selected offer to a publisher associated with the remaining advertisement availability.

5. The method of claim 1, further comprising billing the minimum charge to an advertiser associated with the selected offer.

6. The method of claim 1, wherein the offers have an order and selecting from the offers further includes selecting each of the offers in order before selecting any of the offers a subsequent time.

7. The method of claim 1, wherein selecting the offer further includes maximizing a number of fulfilled advertisement pods.

8. The method of claim 1, wherein the amounts being bid each include a cost per impression amount for the specific advertisement availabilities.

9. The method of claim 1, wherein the offers each include a range of accepted cost per impression amounts for the remaining advertisement availability.

10. The method of claim 1, wherein the budgets for the non-specific advertisement availabilities each include a daily budget for the non-specific advertisement availabilities.

11. A computer-implemented method for assigning remnant advertisement availabilities, comprising:
receiving one or more requests to purchase at least one of a plurality of advertisement availabilities, each of the requests including an amount being paid for a specific advertisement availability among the advertisement availabilities;
determining, as a result of the requests, at least one remaining advertisement availability from the advertisement availabilities that was not purchased;
receiving one or more offers for the remaining advertisement availability, each of the offers including corresponding budgets for one or more non-specific advertisement availabilities;
selecting from the offers an offer having a remaining budget that is greater than or equal to a minimum charge incurred by the remaining advertisement availability; and
assigning the remaining advertisement availability to the selected offer.

12. A computer-implemented system for assigning remnant advertisement availabilities, comprising:
a memory that stores advertisement availabilities;
an advertiser interface that receives one or more bids and one or more offers for the advertisement availabilities from multiple advertiser systems, each of the bids including an amount being bid for a specific advertisement availability among the advertisement availabilities, and each of the offers including a corresponding budget for one or more non-specific advertisement availabilities among the advertisement availabilities;
an advertisement auction module that auctions the advertisement availabilities 11 using the bids and determines, as a result of auctioning the advertisement availabilities, a remaining advertisement availability that was not placed during the auction; and
an offer selection module that selects from the offers an offer having a remaining budget that is greater than or equal to a minimum charge incurred by the remaining advertisement availability, and that assigns the remaining advertisement availability to the selected offer.

13. The system of claim 12, further comprising a publisher interface that receives the advertisement availabilities from one or more publisher systems and stores the received advertisement availabilities in the memory.
